(19) United States
(12) Patent Application Publication
(10) Pub. No.: US 2026/0238414 A1
(43) Pub. Date: Aug. 13, 2026

(54) NETWORK CONTROLLED REPEATER (NCR) CONTROL INFORMATION FOR APERIODIC DOWNLINK ACCESS LINK BEAM INDICATION AND BACKHAUL TIMING

(71) Applicant: SHARP KABUSHIKI KAISHA, Sakai City, Osaka (JP)

(72) Inventors: ZHANPING YIN, Vancouver, WA (US); TOMOKI YOSHIMURA, Sakai City, Osaka (JP)

(21) Appl. No.: 19/156,609

(22) PCT Filed: Jan. 16, 2024
(86) PCT No.: PCT/JP2024/000909

§ 371 Date: Aug. 14, 2025

Related U.S. Application Data
(60) Provisional application No. 63/446,254, filed on Feb. 16, 2023.

(51) Int. Cl. H04L 5/00; H04B 7/06

(52) U.S. Cl. CPC H04L 5/0044; H04B 7/06952; H04L 5/0005

(57) ABSTRACT

A network controlled repeater (NCR) is described. The NCR includes receiving circuitry configured to receive a downlink control information (DCI) from a gNodeB (gNB) for an access link aperiodic downlink (DL) beam indication, including at least an access link DL beam index, an access link DL time resource index, and a configurable field on the backhaul time resource indication. The receiving circuitry may also be configured to determine an aperiodic DL time resource on a backhaul link corresponding to the aperiodic DL time resource on the access link. The receiving circuitry may also be configured to receive and buffer a DL signal on the determined aperiodic DL time resource on the backhaul link. The NCR may also include transmitting circuitry configured to transmit the buffered DL signal from the backhaul link on the aperiodic DL time resource with the indicated beam on the access link.

### TECHNICAL FIELD

The present disclosure relates generally to communication systems. More specifically, the present disclosure relates to network controlled repeater (NCR) control information for aperiodic downlink access link beam indication and backhaul timing.

### BACKGROUND ART

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### SUMMARY OF INVENTION

In one example, a network controlled repeater (NCR) includes: receiving circuitry configured to: receive a downlink control information (DCI) from a gNodeB (gNB) for an access link aperiodic downlink (DL) beam indication, including at least an access link DL beam index, an access link DL time resource index, and a configurable field on a backhaul time resource indication; determine an aperiodic DL time resource on a backhaul link corresponding to the aperiodic DL time resource on the access link; and receive and buffer a DL signal on the determined aperiodic DL time resource on the backhaul link; transmitting circuitry configured to: transmit the buffered DL signal from the backhaul link on the aperiodic DL time resource with the indicated beam on the access link.

In one example, a gNodeB (gNB) includes: transmitting circuitry configured to: transmit a downlink control information (DCI) to a network controlled repeater (NCR) for an access link aperiodic downlink (DL) beam indication, including at least an access link DL beam index, an access link DL time resource index, and a configurable field on the backhaul time resource indication; determine an aperiodic DL time resource on a backhaul link corresponding to the aperiodic DL time resource on the access link; and transmit a DL signal on the determined aperiodic DL time resource on the backhaul link.

In one example, a communication method of a network controlled repeater (NCR), includes: receiving a downlink control information (DCI) from a gNodeB (gNB) for an access link aperiodic downlink (DL) beam indication, including at least an access link DL beam index, an access link DL time resource index, and a configurable field on the backhaul time resource indication; determining an aperiodic DL time resource on a backhaul link corresponding to the aperiodic DL time resource on the access link; receiving and buffering a DL signal on the determined aperiodic DL time resource on the backhaul link; and transmitting the buffered DL signal from the backhaul link on the aperiodic DL time resource with the indicated beam on the access link.

### BRIEF DESCRIPTION OF DRAWINGS

FIG. 1 is a block diagram illustrating one implementation of one or more gNode Bs (gNBs) and one or more user equipment (UEs) in which systems and methods for signaling may be implemented;

FIG. 2 is a block diagram showing an example of an NCR framework;

FIG. 3 is a diagram showing NCR operation for aperiodic dynamic scheduling DL transmission with UL feedback;

FIG. 4 is a diagram showing NCR operation for aperiodic dynamic scheduling UL transmission;

FIG. 5 is a diagram showing NCR operation for aperiodic dynamic scheduling DL transmission without UL feedback;

FIG. 6 is a diagram showing NCR operation for aperiodic dynamic scheduling PDCCH and PDSCH in different slots with UL feedback;

FIG. 7 is a diagram showing methods to indicate the DL backhaul link time resource for an access link DL time resource;

FIG. 8 is a diagram showing methods to indicate the UL backhaul link time resource for an access link UL time resource;

FIG. 9 illustrates various components that may be utilized in a UE;

FIG. 10 illustrates various components that may be utilized in a gNB;

FIG. 11 illustrates various components that may be utilized in an NCR;

FIG. 12 is a block diagram illustrating one implementation of a UE in which one or more of the systems and/or methods described herein may be implemented;

FIG. 13 is a block diagram illustrating one implementation of a gNB in which one or more of the systems and/or methods described herein may be implemented;

FIG. 14 is a block diagram illustrating one implementation of an NCR in which one or more of the systems and/or methods described herein may be implemented;

FIG. 15 is a block diagram illustrating one implementation of a gNB; and

FIG. 16 is a block diagram illustrating one implementation of a UE.

### DESCRIPTION OF EMBODIMENTS

A network controlled repeater (NCR) is described. The NCR may include receiving circuitry configured to receive a downlink control information (DCI) from a gNodeB (gNB) for an access link aperiodic downlink (DL) beam indication, including at least an access link DL beam index, an access link DL time resource index, and a configurable field on a backhaul time resource indication. The receiving circuitry may also be configured to determine an aperiodic DL time resource on a backhaul link corresponding to the aperiodic DL time resource on the access link. The receiving circuitry may also be configured receive and buffer a DL signal on the determined aperiodic DL time resource on the backhaul link. The NCR may also include transmitting circuitry configured to transmit the buffered DL signal from the backhaul link on the aperiodic DL time resource with the indicated beam on the access link.

The access link aperiodic DL time resource index of the NCR may be determined based on a list for DL time resources only, or based on a joint list containing both DL time resources and uplink (UL) time resources.

The aperiodic DL time resource on the backhaul link of the NCR may have the same start symbol and duration as the access link time resource, and wherein the slot for the backhaul link time resource may be within or after the slot with the DL beam indication DCI and before the DL aperiodic time resource on the access link.

If a backhaul time resource indication field is not available in the DL beam indication DCI of the NCR, the aperiodic DL time resource on the backhaul link is determined by a radio resource control (RRC) configured parameter for a DL forwarding delay.

If a backhaul time resource indication field is not available in the DL beam indication DCI of the NCR, the aperiodic DL time resource on the backhaul link may be determined in the slot carrying the beam indication DCI.

If a backhaul time resource indication field is configured in the DL beam indication DCI of the NCR, the aperiodic DL time resource on the backhaul link may be determined by the backhaul time resource indication field, wherein the backhaul time resource indication field indicates the number of slots between the slot of the beam indication DCI and the backhaul link slot or the number of slots between the backhaul link slot and the access link slot.

A gNodeB (gNB) is described. The gNB may include transmitting circuitry configured to transmit a downlink control information (DCI) to a network controlled repeater (NCR) for an access link aperiodic downlink (DL) beam indication, including at least an access link DL beam index, an access link DL time resource index, and a configurable field on the backhaul time resource indication. The transmitting circuitry may also be configured to determine an aperiodic DL time resource on a backhaul link corresponding to the aperiodic DL time resource on the access link. The transmitting circuitry may also be configured to transmit a DL signal on the determined aperiodic DL time resource on the backhaul link.

The access link aperiodic DL time resource index of the gNB may be determined based on a list for DL time resources only, or based on a joint list containing both DL time resources and uplink (UL) time resources.

The aperiodic DL time resource on the backhaul link of the gNB may have the same start symbol and duration as the access link time resource, and wherein the slot for the backhaul link time resource may be within or after the slot with the DL beam indication DCI, and before the DL aperiodic time resource on the access link.

If a backhaul time resource indication field is not available in the DL beam indication DCI of the gNB, the aperiodic DL time resource on the backhaul link is determined by a radio resource control (RRC) configured parameter for a DL forwarding delay.

If a backhaul time resource indication field is not available in the DL beam indication DCI of the gNB, the aperiodic DL time resource on the backhaul link may be determined in the slot carrying the beam indication DCI.

If a backhaul time resource indication field is configured in the DL beam indication DCI of the gNB, the aperiodic DL time resource on the backhaul link may be determined by the backhaul time resource indication field, wherein the backhaul time resource indication field indicates the number of slots between the slot of the beam indication DCI and the backhaul link slot or the number of slots between the backhaul link slot and the access link slot.

A communication method of a network controlled repeater (NCR) is described. The communication method may include receiving a downlink control information (DCI) from a gNodeB (gNB) for an access link aperiodic downlink (DL) beam indication, including at least an access link DL beam index, an access link DL time resource index, and a configurable field on the backhaul time resource indication. The communication method may also include determining an aperiodic DL time resource on a backhaul link corresponding to the aperiodic DL time resource on the access link. The communication method may also include receiving and buffering a DL signal on the determined aperiodic DL time resource on the backhaul link. The communication method may also include transmitting the buffered DL signal from the backhaul link on the aperiodic DL time resource with the indicated beam on the access link.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A), LTE-Advanced Pro and other standards (e.g., 3GPP Releases 8, 9, 10, 11, 12, 13, 14, 15, 16, 17, and/or 18). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB), a g Node B (gNB) or some other similar terminology. As the scope of the disclosure should not be limited to 3GPP standards, the terms “base station,” “Node B,” “eNB,” “gNB” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An gNB may also be more generally referred to as a base station device.

It should be noted that as used herein, a “cell” may be any communication channel that is specified by standardization or regulatory bodies to be used for International Mobile Telecommunications-Advanced (IMT-Advanced) or IMT-2020, and all of it or a subset of it may be adopted by 3GPP as licensed bands or unlicensed bands (e.g., frequency bands) to be used for communication between an eNB or gNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

The 5th generation communication systems, dubbed NR (New Radio technologies) by 3GPP, envision the use of time/frequency/space resources to allow for services, such as eMBB (enhanced Mobile Broad-Band) transmission, URLLC (Ultra Reliable and Low Latency Communication) transmission, and mMTC (massive Machine Type Communication) transmission. And, in NR, transmissions for different services may be specified (e.g., configured) for one or more bandwidth parts (BWPs) in a serving cell and/or for one or more serving cells. A user equipment (UE) may receive a downlink signal(s) and/or transmit an uplink signal(s) in the BWP(s) of the serving cell and/or the serving cell(s).

In order for the services to use the time, frequency, and/or spatial resources efficiently, it would be useful to be able to efficiently control downlink and/or uplink transmissions. Therefore, a procedure for efficient control of downlink and/or uplink transmissions should be designed. Accordingly, a detailed design of a procedure for downlink and/or uplink transmissions may be beneficial.

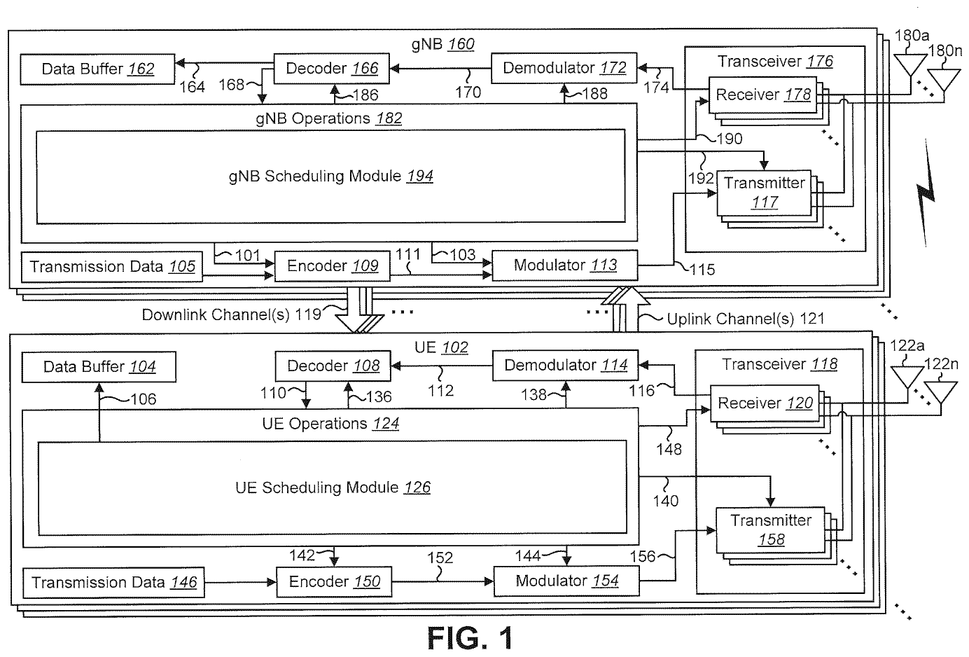

FIG. 1 is a block diagram illustrating one implementation of one or more gNBs 160 and one or more UEs 102 in which systems and methods for signaling may be implemented. The one or more UEs 102 communicate with one or more gNBs 160 using one or more physical antennas 122a-n. For example, a UE 102 transmits electromagnetic signals to the gNB 160 and receives electromagnetic signals from the gNB 160 using the one or more physical antennas 122a-n. The gNB 160 communicates with the UE 102 using one or more physical antennas 180a-n. In some implementations, the term “base station,” “eNB,” and/or “gNB” may refer to and/or may be replaced by the term “Transmission Reception Point (TRP).” For example, the gNB 160 described in connection with FIG. 1 may be a TRP in some implementations.

The UE 102 and the gNB 160 may use one or more channels and/or one or more signals 119, 121 to communicate with each other. For example, the UE 102 may transmit information or data to the gNB 160 using one or more uplink channels 121. Examples of uplink channels 121 include a physical shared channel (e.g., PUSCH (physical uplink shared channel)) and/or a physical control channel (e.g., PUCCH (physical uplink control channel)), etc. The one or more gNBs 160 may also transmit information or data to the one or more UEs 102 using one or more downlink channels 119, for instance. Examples of downlink channels 119 include a physical shared channel (e.g., PDSCH (physical downlink shared channel) and/or a physical control channel (PDCCH (physical downlink control channel)), etc. Other kinds of channels and/or signals may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more physical antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE scheduling module 126.

The UE scheduling module 126 may perform downlink reception(s) and uplink transmission(s). The downlink reception(s) include reception of data, reception of downlink control information, and/or reception of downlink reference signals. Also, the uplink transmissions include transmission of data, transmission of uplink control information, and/or transmission of uplink reference signals.

Also, in a carrier aggregation (CA), the gNB 160 and the UE 102 may communicate with each other using a set of serving cells. Here a set of serving cells may include one primary cell and one or more secondary cells. For example, the gNB 160 may transmit, by using the RRC message, information used for configuring one or more secondary cells to form together with the primary cell a set of serving cells. Namely, the set of serving cells may include one primary cell and one or more secondary cells. Here, the primary cell may be always activated. Also, the gNB 160 may activate zero or more secondary cell within the configured secondary cells. Here, in the downlink, a carrier corresponding to the primary cell may be the downlink primary component carrier (i.e., the DL PCC), and a carrier corresponding to a secondary cell may be the downlink secondary component carrier (i.e., the DL SCC). Also, in the uplink, a carrier corresponding to the primary cell may be the uplink primary component carrier (i.e., the UL PCC), and a carrier corresponding to the secondary cell may be the uplink secondary component carrier (i.e., the UL SCC).

Also, in a single cell operation, the gNB 160 and the UE 102 may communicate with each other using one serving cell. Here, the serving cell may be a primary cell.

In a radio communication system, physical channels (uplink physical channels and/or downlink physical channels) may be defined. The physical channels (uplink physical channels and/or downlink physical channels) may be used for transmitting information that is delivered from a higher layer and/or information that is generated from a physical layer.

### PRACH

For example, in uplink, a PRACH (Physical Random Access Channel) may be defined. In some approaches, the PRACH (e.g., as part of a random access procedure) may be used for an initial access connection establishment procedure, a handover procedure, a connection re-establishment, a timing adjustment (e.g., a synchronization for an uplink transmission, for UL synchronization) and/or for requesting an uplink shared channel (UL-SCH) resource (e.g., the uplink physical shared channel (PSCH) (e.g., PUSCH) resource).

### PUCCH

In another example, a physical uplink control channel (PUCCH) may be defined. The PUCCH may be used for transmitting uplink control information (UCI). The UCI may include hybrid automatic repeat request-acknowledgement (HARQ-ACK), channel state information (CSI) and/or a scheduling request (SR). The HARQ-ACK is used for indicating a positive acknowledgement (ACK) or a negative acknowledgment (NACK) for downlink data (e.g., Transport block(s), Medium Access Control Protocol Data Unit (MAC PDU) and/or Downlink Shared Channel (DL-SCH)). The CSI is used for indicating state of downlink channel (e.g., a downlink signal(s)). Also, the SR is used for requesting resources of uplink data (e.g., Transport block(s), MAC PDU and/or Uplink Shared Channel (UL-SCH)).

Here, the DL-SCH and/or the UL-SCH may be a transport channel that is used in the MAC layer. Also, a transport block(s) (TB(s)) and/or a MAC PDU may be defined as a unit(s) of the transport channel used in the MAC layer. The transport block may be defined as a unit of data delivered from the MAC layer to the physical layer. The MAC layer may deliver the transport block to the physical layer (e.g., the MAC layer delivers the data as the transport block to the physical layer). In the physical layer, the transport block may be mapped to one or more codewords.

### PDCCH

In downlink, a physical downlink control channel (PDCCH) may be defined. The PDCCH may be used for transmitting downlink control information (DCI). Here, more than one DCI formats may be defined for DCI transmission on the PDCCH. Namely, fields may be defined in the DCI format(s), and the fields are mapped to the information bits (e.g., DCI bits).

### PDSCH and PUSCH

A physical downlink shared channel (PDSCH) and a physical uplink shared channel (PUSCH) may be defined. For example, in a case that the PDSCH (e.g., the PDSCH resource) is scheduled by using the DCI format(s) for the downlink, the UE 102 may receive the downlink data, on the scheduled PDSCH (e.g., the PDSCH resource). Alternatively, in a case that the PUSCH (e.g., the PUSCH resource) is scheduled by using the DCI format(s) for the uplink, the UE 102 transmits the uplink data, on the scheduled PUSCH (e.g., the PUSCH resource). For example, the PDSCH may be used to transmit the downlink data (e.g., DL-SCH(s), a downlink transport block(s)). Additionally or alternatively, the PUSCH may be used to transmit the uplink data (e.g., ULSCH(s), an uplink transport block(s)).

Furthermore, the PDSCH and/or the PUSCH may be used to transmit information of a higher layer (e.g., a radio resource control (RRC)) layer, and/or a MAC layer). For example, the PDSCH (e.g., from the gNB 160 to the UE 102) and/or the PUSCH (e.g., from the UE 102 to the gNB 160) may be used to transmit a RRC message (a RRC signal). Additionally or alternatively, the PDSCH (e.g., from the gNB 160 to the UE 102) and/or the PUSCH (e.g., from the UE 102 to the gNB 160) may be used to transmit a MAC control element (a MAC CE). Here, the RRC message and/or the MAC CE are also referred to as a higher layer signal.

### SS/PBCH Block

In some approaches, a physical broadcast channel (PBCH) may be defined. For example, the PBCH may be used for broadcasting the MIB (master information block). Here, system information may be divided into the MIB and a number of SIB(s) (system information block(s)). For example, the MIB may be used for carrying minimum system information. Additionally or alternatively, the SIB(s) may be used for carrying system information messages.

In some approaches, in downlink, synchronization signals (SSs) may be defined. The SS may be used for acquiring time and/or frequency synchronization with a cell. Additionally or alternatively, the SS may be used for detecting a physical layer cell ID of the cell. SSs may include a primary SS and a secondary SS.

An SS/PBCH block may be defined as a set of a primary SS (PSS), a secondary SS (SSS) and a PBCH. In the time domain, the SS/PBCH block consists of 4 OFDM symbols, numbered in terms of OFDM symbols in increasing order from 0 to 3 within the SS/PBCH block, where PSS, SSS, and PBCH with associated demodulation reference signal (DMRS) are mapped to symbols. One or more SS/PBCH blocks may be mapped within a certain time duration (e.g. 5 msec).

Additionally, the SS/PBCH block may be used for beam measurement, radio resource management (RRM) measurement and radio link monitoring (RLM) measurement. Specifically, the secondary synchronization signal (SSS) may be used for the measurement.

In the radio communication for uplink, UL RS(s) may be used as uplink physical signal(s). Additionally or alternatively, in the radio communication for downlink, DL RS(s) may be used as downlink physical signal(s). The uplink physical signal(s) and/or the downlink physical signal(s) may not be used to transmit information that is provided from the higher layer where the information is used by a physical layer.

Here, the downlink physical channel(s) and/or the downlink physical signal(s) described herein may be assumed to be included in a downlink signal (e.g., a DL signal(s)) in some implementations for the sake of simple descriptions. Additionally or alternatively, the uplink physical channel(s) and/or the uplink physical signal(s) described herein may be assumed to be included in an uplink signal (i.e. an UL signal(s)) in some implementations for the sake of simple descriptions.

A network controlled repeater (NCR) works as a physical layer repeater between a gNodeB (gNB) and a user equipment (UE). The NCR can be configured with aperiodic beams and aperiodic time resources for the access link. An access link beam indication downlink control information (DCI) can be used to indicate the access beams and the associated time resources on the access link. It may be beneficial to detail or specify the DCI fields and DCI formats. Furthermore, systems and methods to determine the corresponding backhaul time resources for the indicated access link time resources would be beneficial.

Network controlled repeater (NCR) control information for aperiodic downlink access link beam indication and backhaul timing

Focusing on dedicated compact DCI for downlink (DL) access beam indication and backhaul time resource determination.

An aperiodic DL transmission can be dynamically scheduled by a DL beam indication DCI for access link, i.e. a DL specific DCI. The DCI fields include at least an access link DL beam index, an access link DL time resource index, and a configurable field on the backhaul time resource indication.

The DL time resources list and the DL time resource indexes can be determined by two options:
Option 1: A separate list for DL time resources only
Option 2: A joint list contains both DL time resources and UL time resources

A backhaul link DL slot and time resource should be determined for the indicated access link DL time resource. The backhaul link DL slot should be within or after the slot with the DL beam indication DCI, and before the DL aperiodic time resource on the access link.

A backhaul time resource indication field is configurable to be present or not. It defines a DL forwarding delay or a DL backhaul timing. Several methods can be considered:
Method 1: Use RRC configured parameter for a DL forwarding delay, not present in the DCI
Method 2: Implicitly or explicitly by the beam indication DCI
   Approach 1: Implicitly determined by the slot carrying the beam indication DCI
   Approach 2: Explicit timing if included in the DCI
      Scheme1: Indicate the number of slots between the slot of the beam indication DCI and the backhaul link slot
      Scheme 2: Indicate the number of slots between the backhaul link slot and the access link slot
      Use RRC configured parameter if not included in the DCI.
         Network controlled repeater (NCR) control information for aperiodic uplink access link beam indication and backhaul timing
         Focusing on dedicated compact DCI for uplink (UL) access beam indication and backhaul time resource determination.

An aperiodic UL transmission can be dynamically scheduled by an UL beam indication DCI for access link, i.e. an UL specific DCI. The DCI fields include at least an access link UL beam index, an access link UL time resource index, and a configurable field on the backhaul time resource indication.

The UL time resources list and the UL time resource indexes can be determined by two options:
Option 1: A separate list for UL time resources only
Option 2: A joint list contains both DL time resources and UL time resources

A backhaul link UL slot and time resource should be determined for the indicated access link UL time resource. The backhaul link UL slot should be after the slot of the UL aperiodic time resource on the access link.

A backhaul time resource indication field is configurable to be present or not. It defines an UL forwarding delay or an UL backhaul timing. Several methods can be considered:
Method 1: Use RRC configured parameter for an UL forwarding delay, not present in the DCI
Method 2: Use explicit timing if included in the DCI
   Scheme 1: Indicate the number of slots between the slot of the beam indication DCI and the backhaul link slot
   Scheme 2: Indicate the number of slots between the access link slot and the backhaul link slot
   Use RRC configured parameter if not included in the DCI
      Network controlled repeater (NCR) control information for dynamic scheduled transmissions
      Focusing on unified DCI formats for DL and/or UL access beam indication and backhaul time resource determination.
      Case 1: a DL Transmission with UL Feedback May be Scheduled by Two DCIs for DL Transmission and UL Transmission Respectively.

The gNB should guarantee the correct timing and time resources are scheduled. The NCR does not need to know the relationship between the DL and UL transmissions.

In one method, the gNB signals a dedicated DL beam indication DCI and a dedicated UL beam indication DCI.

In another method, a new beam indication DCI for either DL or UL beam indication for access link can be specified. The DCI fields includes at least an access link beam index, an access link time resource, and a configurable field on the backhaul time resource indication.

The UL time resources list and the time resource indexes can be determined by two options:
Option 1: Separate lists for DL time resources and UL time resources respectively
Option 2: A joint list contains both DL time resources and UL time resources

A backhaul time resource indication field is configurable to be present or not. The interpretation of the field is determined based on the type of the time resource, i.e. DL or UL
Method 1: NCR evaluates the time resource, i.e. DL or UL first based on the slot configure, then follow the corresponding operation
   The backhaul time resource indication field indicates a DL forwarding delay if a DL time resource is indicated
   The backhaul time resource indication field indicates a UL forwarding delay if a UL time resource is indicated
Method 2: A field is included in the DCI to explicit indicate whether the DCI is for DL or UL scheduling. The gNB should always indicate a time resource with the same direction.
Use RRC configured parameters if backhaul time resource indication field is not included in the DCI
   Case 2: A DL Transmission with UL Feedback May be Scheduled by a Beam Indication DCI with Multiple Beams and Time Resources.

A verbose DCI format can be specified for aperiodic beam indication with one or more time resources and beams. The DCI fields should include at least an access link DL beam index, an access link DL time resource index, an access link UL beam index, an access link UL time resource index, and one or two configurable fields on the backhaul time resource indication.
Option 1: two backhaul time resource indications for DL and UL respectively.
Option 2: A single forwarding delay may be configured and applied for both DL and UL.

Coverage is a fundamental aspect of cellular network deployments. Mobile operators rely on different types of network nodes to offer blanket coverage in their deployments. Deployment of regular full-stack cells is one option but it may not be always possible (e.g., no availability of backhaul) or economically viable.

As a result, new types of network nodes have been considered to increase mobile operators' flexibility for their network deployments. For example, Integrated Access and Backhaul (IAB) has been introduced as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

While an RF repeater presents a cost effective means of extending network coverage, it has its limitations. An RF repeater simply does an amplify-and-forward operation without being able to take into account various factors that could improve performance. A network-controlled repeater is an enhancement over conventional RF repeaters with the capability to receive and process side control information from the network. Side control information could allow a network-controlled repeater to perform its amplify-and-forward operation in a more efficient manner. Potential benefits could include mitigation of unnecessary noise amplification, transmissions and receptions with better spatial directivity, and simplified network integration.

The study on NR network-controlled repeaters, multiple side control information are investigated and some of them (e.g., beam information, ON-OFF information, and TDD DL-UL configuration) are identified as necessary features with detailed design on the signaling. Solutions on repeater management may be studied to enable the network integration.

The objectives of NR NCR may focus on scenarios and assumption listed below:
Network-controlled repeaters are inband RF repeaters used for extension of network coverage on FR1 and FR2 bands based on the NCR model in TR38.867
For only single hop stationary network-controlled repeaters
The NCR is transparent to the UE
Network-controlled repeater can maintain the gNB-repeater link and repeater-UE link simultaneously

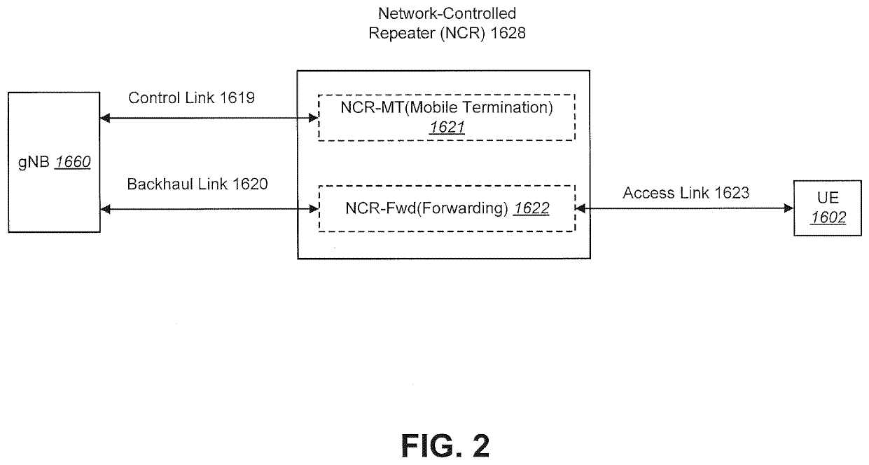

With these considerations, NR NCR supports the following features:
Specify the signaling and behavior of the following side control information for controlling the NCR-Fwd in the areas of Beamforming, UL-DL TDD operation, and ON-OFF information.
Specify control plane signaling and procedures for the configuration of signaling for side control information indication.
   FIG. 2 is a block diagram showing an example of an NCR 1628 framework. The NCR-MT 1621 (mobile termination) is defined as a function entity to communicate with a gNB 1660 via Control link 1619 (C-link) to enable the information exchanges (e.g. side control information). The C-link 1619 is based on NR UE interface. The side control information is at least for the control of NCR-Fwd 1622 (forwarding).

The NCR-Fwd 1622 is defined as a function entity to perform the amplify-and-forwarding of UL/DL RF signal between gNB 1660 and UE 1602 via backhaul link 1620 and access link 1623. The behavior of the NCR-Fwd 1622 will be controlled according to the received side control information from gNB 1660. The NCR-Fwd 1622 includes the backhaul link 1620 and the access link 1623.

The NCR 1628 can obtain the synchronization signals, e.g. SSBs and PBCH, MIB, and SIB, etc. on the NCR-MT 1621 and/or NCR-Fwd 1622. Furthermore, the NCR 1628 can receive the side information on NCR local configuration on control link 1619 with NCR-MT 1621.

The control link 1619 and the backhaul link 1620 at NCR 1628 can be performed simultaneously or in time division multiplexing (TDM). Specifically:
The DL of C-link 1619 and DL of backhaul link 1620 can be performed simultaneously (FDM) or in TDM way.
The UL of C-link 1619 and UL of backhaul link 1620 can be performed in TDM way.
Multiplexing is under the control of gNB 1660 with consideration for NCR 1628 capability.
Simultaneous transmission of the UL of C-link 1619 and UL of backhaul link 1620 is subject to NCR 1628 capability.
   FDM may be supported, but resource collision may occur between forwarded traffic and C-link 1619.
   If different subband regions are configured, then it is up to NCR 1628 capability.

For the TDD UL/DL configuration of network controller repeater (NCR 1628), at least semi-static TDD UL/DL configuration is needed for network-controlled repeater for links including C-link 1619, backhaul link 1620 and access link 1623. How to handle of flexible symbols should be studied further.

Note that the same TDD UL/DL configuration is always assumed for backhaul link 1620 and access link 1623. Also, the same TDD UL/DL configuration is assumed for C-link 1619 and backhaul link 1620 and access link 1623 if NCR-MT 1621 and NCR-Fwd 1622 are in the same frequency band. For the flexible symbol based on the semistatic configuration (e.g., TDD-UL-DL-ConfigCommon, TDDUL-DL-ConfigDedicated), the default behavior of the NCR-Fwd is expected to be OFF or not forwarding over these symbols. If dynamic DL/UL operation is supported by NCR-MT and/or NCR-Fwd, the flexible symbols may follow the dynamic TDD indication from gNB 1660 to the NCR-MT and/or NCR-Fwd.

Additional side information can be signaled by the gNB 1660 to further determine the access link 1623 and backhaul link 1620 transmissions within the DL and/or UL allocations.

Within the DL slots/symbols provided by the TDD UL/DL configurations, the NCR 1628 should further decide the slots/symbols used as:
Backhaul DL slots/symbols: the NCR 1628 receives the DL, if a slot/sym is indicated by gNB 1660 to be forwarded on access link 1623, the NCR 1628 buffers the received DL signals.
Access DL slots/symbols: if a slot/symbol is indicated by gNB 1660 to transmit as an access DL, the NCR 1628 transmits a previously buffered DL from gNB 1660 in the slot/symbol.

Within the UL slots/symbols provided by the TDD UL/DL configurations, the NCR 1628 should further decide the slots/symbols used as:
Access UL slots/symbols: if a slot/symbol is indicated by gNB 1660 to receive an access UL, the NCR 1628 receives a UL transmission on the access link, and buffers the UL signal.
Backhaul UL slots/symbols: if a slot/symbol is indicated by gNB 1660 to forward signals from access link, the NCR 1628 transmits a buffered UL signal to the gNB 1660 in the slot/symbol.

### NCR Beam Determination for Backhaul Link

For DL and UL transmissions on the backhaul link, a backhaul beam is used. The backhaul beam is determined separately from the beams on the access link. The access beam index is based on the beams configured for the NCR. The backhaul beam is based on beams configured at gNB. A single backhaul beam may be configured for the backhaul link resource even if one or multiple beams are configured for the access link. Additionally, the gNB may configure more than one beams for the backhaul link resources, the number of beams and the duration of each beam on the backhaul link resources should be configured separately from the UL time resources of the access link, i.e. the backhaul link beams use different beam indexes that are numbered separately from NCR beams.

The NCR backhaul link beam can be determined by the beam for the control link or by explicit indication for the backhaul beam. Since the NCR is in fixed location to a gNB, the beam direction and condition could be quite stable. Both semi-static and dynamic beam indication may be used for the backhaul link.

For semi-static beam indication for backhaul link is supported as follows.
If the beam indication framework in Rel-15 is used for NCR-MT, the DL beam is indicated by medium access control control element (MAC CE) to select one of TCI state ID from the RRC-configured list of beams for C-link, and the UL beam is indicated by SRI on C-link via MAC CE.
If the beam indication framework in Rel-17 is used for NCR-MT, the DL and UL beam are indicated by MAC CE to select one of TCI state ID from the RRC-configured list of beams for C-link.

If explicit beam indication is not present for the backhaul link, the following predefined rules are applied to determine the beam for backhaul link.
In the time domain resource with simultaneous downlink reception or uplink transmission in C-link and backhaul link, the beam of backhaul link is the same as the beam of C-link regardless of whether there is beam indicated by the dedicated signal for backhaul link.
In the time domain resource without simultaneous downlink reception or uplink transmission in C-link and backhaul link, if the NCR does not support capability with the new signaling for backhaul beam indication or if no beam is indicated for backhaul link by the dedicated signal,
   When Rel-15/16 beam indication framework is used for C-link, the beam determined by QCL assumption for CORESET with the lowest ID and spatial relationship for PUCCH with lowest PUCCH resource ID in the Clink is applied for the DL and UL of backhaul link, respectively.
   When Rel-17 beam indication framework (i.e., unified TCI framework) is used for C-link, the indicated unified TCI for C-link DL and UL is applied for the DL and UL of backhaul link, respectively.

Otherwise, the beam indicated by the dedicated signaling is applied for backhaul link.

For a DL transmission on the access link, the NCR needs to monitor DL transmissions on the control link and backhaul link in a slot and buffer the indicated corresponding signals from the backhaul link to the indicated DL time resource(s) with the indicated downlink beam(s).

For UL transmissions on the access link, the NCR needs to monitor and buffer the UL transmissions on the access link from UE(s) in a slot on the indicated time resources with the indicated uplink access beam(s), and forward the buffered signals to the gNB in another indicated UL time resource(s) on the backhaul link.

### NCR Periodic Beam Indication and Time Resource Indication for Access Link Configuration

The beam indication on the access link also includes the corresponding time resource allocation for each indicated beam. For each periodic beam indication for access link, one RRC signaling is used including the information of a list of

$$X ( 1 \leq X \leq {X}_{max} )$$

forwarding resource, each is defined as {Beam index, time resource}.

The value of

Xₘₐₓ
may be configured with a value of 1, 2, 4, up to the maximum number of beams supported on the access link. The

Xₘₐₓ
may be a fixed value, e.g. 2, or 4, etc. The information to characterize the supported physical beam of NCR-Fwd for access link is informed to gNB and NCR via Operations, Administration and Maintenance (OAM) telecommunication management. How to characterize the beam information is based on implementation (e.g., declaration from NCR vendor). Also, the beam(s) used by NCR-Fwd for access link is configured for gNB and NCR by OAM based on implementation. The beam index in SCI corresponds to the configured beam(s) sequentially.

Each time a resource is defined by {starting slot defined as the slot offset in one period, starting symbol defined by symbol offset within the slot, duration defined by the number of symbols} with dedicated field. The periodicity is configured as part of the RRC signaling for periodic beam indication. The same periodicity is assumed for all time resource(s) in one periodic beam indication. The reference SCS is configured as part of the RRC signaling for periodic beam indication. The same reference SCS is assumed for all time resource(s) in one periodic beam indication.

To reduce the interference, and to enhance potential power management at NCR, the periodic beam indication may include frequency domain allocation information beside the time resource information. A frequencyDomainAllocation information element structure may be used. Thus, the NCR only needs to listen, buffer and forward only the indicated resource blocks (RBs) within the BWP. For example, the frequency domain configuration may include a starting RB index and a number of RBs for the periodic transmission. In case of frequency hopping is configured, a frequencyHoppingOffset should be configured. Alternatively, a second RB index may be included.

In summary, periodic beam indications with resource configurations for NCR access link include:
A periodicity in a number of slots.
Beam index and time resource pairs can be configured by RRC.
Each time resource includes a slot index in the period, symbol index in the slot and the number of symbols.

The side information is delivered on the control link to NCR-MT. The CRC bits of the PDCCHs carrying side control information are scrambled by a new dedicated RNTI. This is only applicable only for NCR-MT.

A periodic resource on the access link can be a DL period resource if it is allocated in the DL slots/symbols. A periodic resource link on the access can be a UL period resource if it is allocated in the UL slots/symbols.

### NCR Aperiodic Beam Indication and Time Resource Indication for Access Link Configuration

For a dynamic scheduled transmission, the NCR should be signaled with an aperiodic beam indication for the access link at least.

For each aperiodic beam indication for access link, one DCI is used with the information defined by:
Lₘₐₓ fields are used to indicate the beam information and each field refers to one beam index. The bitwidth of this field is determined by the number of beams used for access link.
Tₘₐₓ fields are used to indicate the time resource. A list of time resource is predefined by RRC signaling. The bitwidth of this field for time resource indication is determined by the length of list. The value of Tₘₐₓ may be Tₘₐₓ=1 or Tₘₐₓ=Lₘₐₓ. How to define the association between time indication and beam indication should be further clarified.
Each time resource is defined by {Starting slot defined as the slot offset, starting symbol defined by symbol offset within the slot, duration defined by the number of symbols} with dedicated field.

There is no periodicity field in aperiodic beam indication. However, the default periodicity should be the same as the TDD UL/DL configuration if configured. The slot offset value is then refer to slot index in the configured TDD configuration. The IE TDD-UL-DL-ConfigCommon is either broadcasted within SIB 1 or configured to the UE using dedicated RRC signaling. When it is provided by RRC signaling then it is mandatory IE and when it is provided via SIB1, this IE is optional for TDD cells.

This IE configures the UE with at least one DL/UL pattern. Pattern1 is mandatory and pattern2 is optional but by including pattern2, the network can have additional scheduling flexibility. Both pattern1 and pattern2 contain same parameters but usually of different values. The procedure for determining DL/UL pattern depends upon whether or not pattern2 is configured within TDD-UL-DL-ConfigCommon. If only pattern1 is configured. a single DL/UL pattern is repeated periodically according to dl-UL-TransmissionPeriodicity. If both pattern1 and pattern2 are configured, two DL/UL patterns (pattern1 and pattern2) are placed next to each other. These two concatenated patterns jointly repeat with periodicity given by dl-UL-TransmissionPeriodicity (from pattern1)+dl-UL-TransmissionPeriodicity (from pattern2).

Additionally or alternatively, if TDD-UL-DL-ConfigCommon is not configured, the time resources can be dynamically allocated by the gNB by slot format indication. In this case,
If the slot offset is included in the time resource configuration, a default periodicity can be used. The default periodicity can be fixed or can be configured by RRC signaling, e.g. the default periodicity can be 10 slots or 20 slots.
If there is no slot offset field in the time resource configuration, the resource is assumed to be available in every slot. The time resource may be a DL time resource or an UL time resource based on the slot format indication.

If the beam indication time resource includes all DL symbols, it is a DL beam indication. If the beam indication time resource includes all UL symbols, it is a UL beam indication. For a cell configured with semi-static TDD UL/DL configurations, the flexible symbols, if any, cannot be used by the NCR. Thus, there should be no time resource with mixed DL and UL symbols.

For a dynamic scheduled DL transmission, the aperiodic beam indication for the access link should indicate one or more DL beams with time resource allocation for each beam. For a dynamic scheduled UL transmission, the aperiodic beam indication for the access link should indicate one or more UL beams with time resource allocation for each beam.

Two options of determining time resource indexes can be considered. The methods of time resources indexes may impact the DCI formats to be used for the aperiodic beam indication.

### Option 1: Separate List and Indexes for DL Time Resources and UL Time Resources

In one option, the DL aperiodic time resources are indexed separately from the UL aperiodic time resources. Thus, two separate time resources lists are composed with independent indexes for DL aperiodic time resources and UL aperiodic time resources respectively. In this case, an aperiodic DL time resource is always configured with all DL symbols, and an aperiodic UL time resource is always configured with all UL symbols.

### Option 2: a Single List for Both DL Time Resources and UL Time Resources

In another option, a single time resource list is configured with indexes including both DL aperiodic time resources and UL aperiodic time resources in the single list. In this case, whether the time resource is a DL time resource or a UL time resource is implicitly determined based on the slot configuration of the configured slot offset of the given aperiodic time resource.

Additionally, to reduce the interference, and to enhance potential power management at NCR, the aperiodic beam indication may include frequency domain allocation information beside the time resource information. A frequencyDomainAllocation information element structure may be used. Thus, the NCR only needs to listen, buffer and forward only the indicated resource blocks (RBs) within the BWP. For example, the frequency domain configuration may include a starting RB index and a number of RBs for the periodic transmission. In case of frequency hopping is configured, a frequencyHoppingOffset should be configured. Alternatively, a second RB index may be included.

The side information carried by the dynamic DCI for aperiodic beam indication may be delivered on the control link to NCR-MT. The CRC bits of the PDCCHs carrying side control information are scrambled by a new dedicated RNTI. This is only applicable only for NCR-MT.

Dynamic scheduled aperiodic DL and/or UL transmissions with NCR

The NCR is transparent to UE, the NCR may not know the type of DL channel forwarded to the UE. There may be two types of DL transmissions in general for a dynamically scheduled DL transmission.

Type 1: a PDCCH and/or PDSCH Transmission with UL Feedback, e.g. PUCCH or PUSCH

In one type, UL feedback is expected from UE for a DL transmission from the gNB. The feedback can be any scheduled or triggered UL signal, e.g. a PUCCH for HARQACK feedback, and/or a PUSCH, and/or a sound reference signal (SRS), and/or a aperiodic CSI-RS, etc.

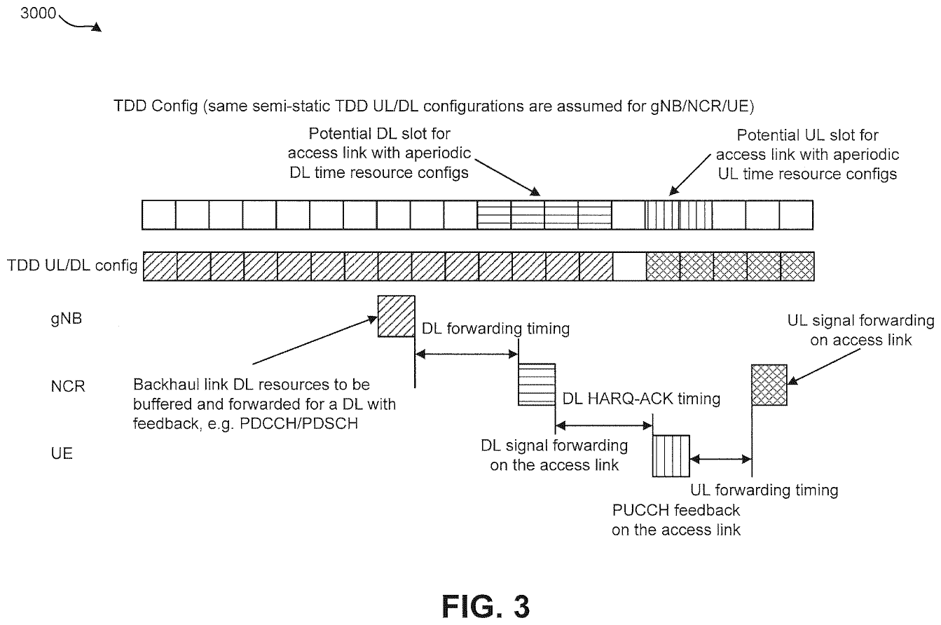

FIG. 3 is a diagram 3000 showing NCR operation for aperiodic dynamic scheduling DL transmission with UL feedback. FIG. 3 shows an example for the process of an aperiodic PDSCH transmission with NCR forwarding when a HARQACK feedback is expected from the UE.

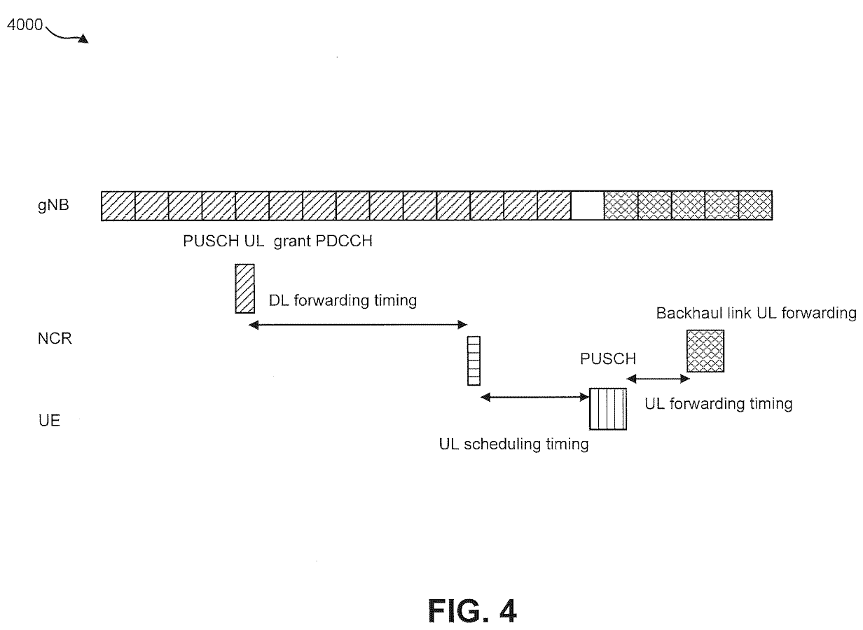

Similarly, a dynamic scheduled PUSCH transmission can also be a Type 1 transmission. As shown below in FIG. 4, for an aperiodic PUSCH scheduling and transmission, the NCR should forward the PUSCH scheduling DCI to the UE first, then listen the PUSCH from the UE and forward the received UL signal to the gNB.

FIG. 4 is a diagram 4000 showing NCR operation for aperiodic dynamic scheduling UL transmission.

Since the NCR is a repeater and cannot decode the messages between the gNB and the UE, the NCR may not differentiate whether a dynamic DL transmission with HARQ-ACK feedback and a dynamically scheduled UL transmission. The NCR only needs to know the time resources to be used on the access link as well as the corresponding time resources on the backhaul link.

A Type 1 transmission may be divided into two separate parts, a DL transmission part and an UL transmission part. The DL transmission part consists of the DL reception in an aperiodic DL time resource on the backhaul link and the DL forwarding in an aperiodic DL time resource on the access link. The UL transmission part consists of the UL reception in an aperiodic UL time resource on the access link and the UL forwarding in an aperiodic UL time resource on the backhaul link.

Type 2: a DL Signal without UL Feedback

In another type, an UL feedback is not expected or not needed from UE for a DL transmission from the gNB. FIG. 4 shows an example for the process of an aperiodic DL transmission with NCR forwarding when no UL feedback is expected from the UE. This is a simplified version of FIG. 3. This scenario is usefully when a broadcast or groupcast PDCCH and/or PDSCH is transmitted by the gNB. A Type 2 transmission includes only a DL transmission part, which consists of the DL reception in an aperiodic DL time resource on the backhaul link and the DL forwarding in an aperiodic DL time resource on the access link.

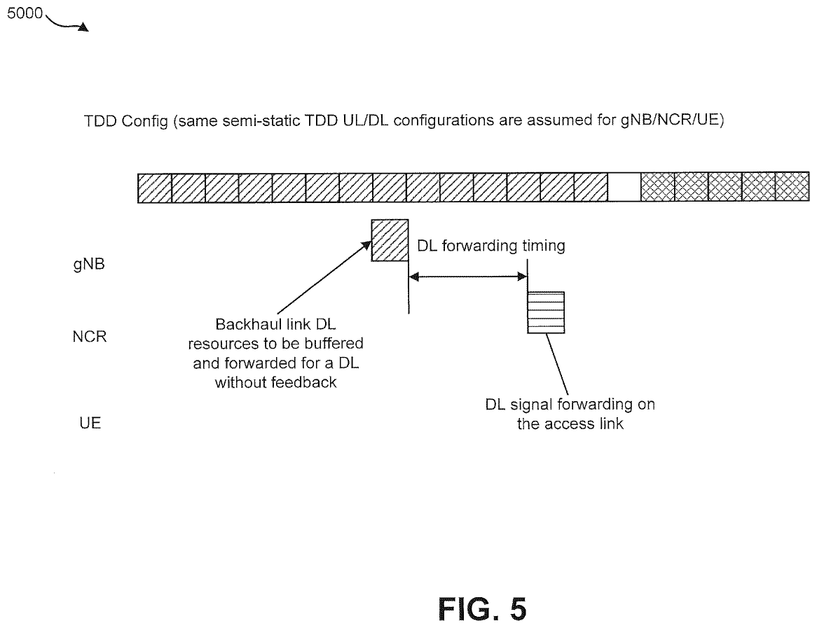

FIG. 5 is a diagram 5000 showing NCR operation for aperiodic dynamic scheduling DL transmission without UL feedback.

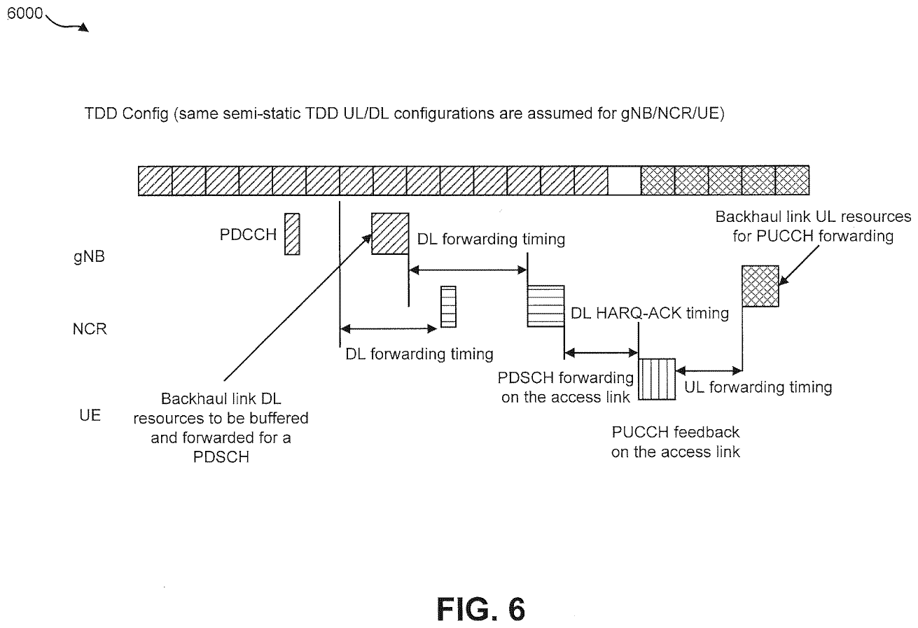

In FIG. 3, it is assumed that the PDCCH and PDSCH is transmitted together in a single aperiodic time resource in a slot. A PDCCH may also be allocated with a different aperiodic time resource from the PDSCH in the same of different slots, e.g. the PDCCH can be transmitted in an earlier slot, and the PDSCH can be transmitted in a later slot determined by the k0 parameter in the scheduling DCI, as shown in FIG. 6. In this case, both the PDCCH time resource and the PDSCH time resource should be forwarded to the UE by the NCR.

The separate DL time resources associated with a single UL response in FIG. 6 can be treated as a combination of a Type 1 and a Type 2 transmission, e.g. a Type 1 DL transmission of the PDSCH with HARQ-ACK feedback, and a Type 2 DL transmission of the PDCCH without feedback. Alternatively, the two separate DL time resources can be treated as a single DL transmission in a Type 1 DL transmission.

FIG. 6 is a diagram 6000 showing NCR operation for aperiodic dynamic scheduling PDCCH and PDSCH in different slots with UL feedback

Dynamic scheduling DCI for aperiodic DI and/or UL transmissions with NCR

At the NCR, DL and UL time resources dynamically indicated to the UE in the scheduling DCI should be mapped to the access link aperiodic DL time resources and aperiodic UL time resources configured for the NCR respectively. The detailed PDSCH and/or PUSCH and/or PUCCH configuration may not be known by the NCR.

The Lₘₐₓ fields are used to indicate the beam information and each field refers to one beam index. The bitwidth of this field is determined by the number of beams used for access link. The Tₘₐₓ fields are used to indicate the time resource in a scheduling DCI for NCR access link. The bitwidth of this field for time resource indication is determined by the length of list.

Depending on the types of lists for aperiodic time resources and the number of time resources can be indicated in an access link beam indication DCI, different methods may be used to schedule the aperiodic DL and/or UL transmissions.

### Case 1: Only One Time Resource in a Dynamic Access Link Beam Indication DCI

If only Tₘₐₓ=1 is supported, an aperiodic beam indication DCI can only indicate one time resource corresponding to the indicated beam. Normally, only one access beam index is indicated in the DCI.

In this case, two separate DCIs are needed to indicate a Type 1 aperiodic DL transmission with UL feedback, i.e. one DCI to indicate an aperiodic beam with time resource for the DL transmission, and one DCI to indicate an aperiodic beam with time resource for the UL transmission.

Thus, in one alternative (Alternative 1), it is better to use different DCI formats for DL and UL scheduling, e.g.:
A new DCI can be specified for aperiodic DL beam indication. The aperiodic DL beam indication DCI can be defined based on a DL scheduling DCI format, e.g, DCI format 1_0/1_1/1_2 to indicate a beam and a DL time resource on the access link. The new DCI format may be DCI format 1_3 or DCI format 4_1.
A new DCI can be specified for aperiodic UL beam indication. The aperiodic UL beam indication DCI can be defined based on an UL scheduling DCI format, e.g, DCI format 0_0/0_1/0_2 to indicate a beam and an UL time resource on the access link. The new DCI format may be DCI format 0_3 or DCI format 4_0.

The DL or UL dedicated DCI formats provides simpler behavior for NCR operation. The NCR just follows the DCI format for DL operation or UL operation respectively.

In one option (Option 1), since DL and UL scheduling DCIs are different, different time resources lists and time resource indexes are configured for DL time resources and UL time resources respectively. Thus, the time resource index in the DL beam indication indicates a time resource in the DL time resource list, and the time resource index in the UL beam indication indicates a time resource in the UL time resource list. Since the number of bits for the time resource is determined by the number of time resources in the corresponding list, the number of bits for the time resource can be smaller in the aperiodic beam indication DCI.

In another option (Option 2), a single time resources list with time resource indexes is configured for both DL time resources and UL time resources. Thus, the time resource index in the DL beam indication should indicate a time resource allocated with DL symbols only, and the time resource index in the UL beam indication should indicate a time resource allocated with UL symbols only. Also, since both DL and UL time resources are included in the list, the number of bits for the time resource is larger in the aperiodic beam indication DCI. The gNB should guarantee that a DL aperiodic time resource is indicated in the time resource index of an aperioidic DL beam indication, and an UL aperiodic time resource is indicated in the time resource index of an aperioidic UL beam indication.

In another alternative (Alternative 2), a new DCI format may be defined for NCR to indicate an access beam for either a DL time resource or an UL time resource. The beam indication DCI can be defined based on a DL scheduling DCI format, e.g, DCI format 1_0/1_1/1_2 or an UL scheduling DCI format, e.g, DCI format 0_0/0_1/0_2. For example, a new DCI for the access link beam indication can be defined as DCI format 1_4 or DCI format 4_2.

In Alternative 2, a single time resources list with time resource indexes should be configured for both DL time resources and UL time resources. The NCR should first determine whether the beam indication is for a DL transmission, or an UL transmission based on slot allocation of the indicated time resource. The NCR then performs the necessary repeating operation accordingly for a DL or an UL transmission.

Alternatively or additionally, a dedicated field can be included in the new DCI format to indicate if this is a DL scheduling DCI or UL scheduling DCI. The field can be one bit, e.g. a “0” is a DL scheduling, and “1” is an UL scheduling, and vice versa. If a single time resources list with both DL time resources and UL time resources is used, the gNB should make sure that the type of time resource matches the indicated DL or UL scheduling type. Furthermore, since DL and UL scheduling is indicated explicitly, the DCI can use separate time resources indexes for DL and UL if different time resources lists and time resource indexes are configured for DL time resources and UL time resources respectively.

The new DCI format in Alternative 2 may be configured additionally to the new DCI formats in Alternative 1. The DCI format in Alternative 2 can be a more complex DCI format, and the DCIs in Alternative 1 can be compact DCI formats.

If a single beam is indicated with a single time resource, the beam can be mapped to the time resource without confusion. However, in some cases, the access link beam indication DCI may indicate more than one beams with only one time resource. How to associate the indicated beams to the symbols in the time resource should be further specified.

This may be a useful use case when the indicated time resource includes both PDCCH and PDSCH, and a different beam is applied for the PDCCH from the beam for the PDSCH. To limit the payload size of a DCI, the number of beams in the DCI can be limited to a maximum value, e.g. 2 or 3, etc. The symbols in the time resource should then be mapped to these beams in the order of the indicated beam indexes.

Use two beams in the aperiodic beam indication as an example:
In one option, the first beam should be used in the first several symbols in the time resource. The number of symbols for the first beam may be configured by higher layer signaling. For example, depending on the control resource set (CORESET) region, the first beam may be confined in the first 1, 2 or 3 symbols. The second beam is then applied in the remaining symbols in the time resource.
In another option, the time resources are evenly distributed among the beams. The number of symbols for the first beam is given by the floor (L/2) or ceil (L/2), where L is the duration of the time resource in a number of symbols. The second beam is then applied in the remaining symbols in the time resource.

If there are more than 2 beams are indicated, the first beam should be used in the first several symbols in the time resource. The number of symbols for the first beam may be configured by higher layer signaling. And the remaining symbols can be divided by the other beams follow a fixed or configured rule.

Case 2: More than One Time Resources in a Dynamic Access Link Beam Indication

In another case, Tₘₐₓ may be more than 1 in an access link beam indication DCI. Thus, more than one time resources for one or more beams can be indicated in a beam indication DCI. Normally, the Tₘₐₓ=Lₘₐₓ, i.e. the number of beams is the same as the number of time resources, and a time resources can be mapped to the beams in the order of the beams and time resources in the DCI.

The Tₘₐₓ may be used to indicate different combinations of DL and/or UL time resources, i.e. one or more DL time resources and one or more UL time resources. For example, more than one DL time resources, or more than one UL time resources, or one DL time resource and one UL time resource, etc.

Especially, if a dynamic beam indication DCI can indicate one DL time resource and one UL time resource, a new DCI format may be defined for NCR to indicate a Type 1 dynamic scheduled transmission. A Type 2 dynamic scheduled transmission can be achieved by indicating only one DL time resource in the dynamic beam indication DCI.

The new DCI should include one or more beam indications. The new DCI for the access link beam indication can be defined as DCI format 1_5 or DCI format 4_3. The new DCI format may be configured additionally to the new DCI formats with one time resource only. The DCI format with more than one time resources can be a more complex DCI format, and the DCIs for one time resource only can be compact DCI formats.

To support a DL transmission with UL feedback, an aperiodic beam indication DCI can indicate one DL time resource index and one UL time resource index. In one option, different time resources lists and time resource indexes are configured for DL time resources and UL time resources respectively. In another option, a single time resources list with time resource indexes can be configured for both DL time resources and UL time resources.

Moreover, if the DL time resource and the UL time resource are configured for a given UE, the NCR may be configured with only one beam index since the DL beam and the UL beam are assumed to be the same on the access link. However, separate beams for DL and UL are more flexible, and the gNB may schedule the DL and UL transmissions targeted to different UEs.

The aperiodic DL time resource and the aperiodic UL time resource on the access link should occupy the same time resources as indicated to the UE from gNB. Thus, the timing relationship between the aperiodic DL time resource and the corresponding aperiodic UL time resource on the access link should be the same as the timing indicated to the UE.

For example, if the aperiodic DL time resource is for a PDSCH with HARQ-ACK feedback, the distance between the aperiodic DL time resource and the corresponding aperiodic UL time resource on the access link should be the same as the DL to HARQACK timing k1 for the given DL transmission indicated to the UE. Similarly, if the aperiodic DL time resource is for a PDCCH with an UL grant for a PUSCH, the distance between the aperiodic DL time resource and the corresponding aperiodic UL time resource on the access link should be the same as the UL scheduling timing k2 for the given UL transmission indicated to the UE.

Note that this timing information is implicitly determined at the NCR by the DL aperiodic beam indication and the corresponding UL aperiodic beam indication. Depending on the DCI formats and side information included in the DCI, the NCR may or may not associate the aperiodic DL time resource and the aperiodic UL time resource on the access link.

For an indicated access link aperiodic DL time resource, the NCR should also determine a corresponding backhaul link aperiodic DL time resource to be buffered and forwarded on the access link aperiodic DL time resource. The time between the end of the aperiodic DL time resource on the backhaul link and the corresponding aperiodic DL time resource on the access link represents a downlink (DL) forwarding delay at the NCR.

Similarly, for an indicated access link aperiodic UL time resource, the NCR should also determine a corresponding backhaul link aperiodic UL time resource to forward the buffered signal from the access link aperiodic UL time resource. The time between the end of the aperiodic UL time resource on the access link and the corresponding aperiodic UL time resource on the backhaul link represents an uplink forwarding delay at the NCR.

Thus, for an aperiodic DL or UL transmission, new parameters are needed at the NCR to determine the association between the aperiodic DL or UL time resources on the backhaul link and access link. The information for the DL and UL time resources on the backhaul may be indicated to the NCR from the gNB via higher layer signaling or by the dynamic beam indication DCI.

### Backhaul Link DL Time Resource Determination for a Dynamic DL Access Link Beam Indication

For an aperiodic DL transmission, the gNB should indicate the aperiodic DL beam indication with beam, aperiodic DL time resource index on the access link for NCR forwarding to a UE; and the aperiodic DL time resource on the backhaul link for NCR reception/buffering from the gNB. The aperiodic DL time resource on the backhaul link may be determined by a downlink forwarding delay information and/or DL time resource allocation/indication on the backhaul link.

Several methods can be considered to determine the backhaul link DL time resource for an aperiodic DL transmission on the access link.

Method 1: specify a DL forwarding delay parameter with higher layer signaling A downlink forwarding delay information can be defined between the end of backhaul link DL reception to the access link DL transmission. The DL forwarding delay can be signaled implicitly or explicitly. The gNB can indication a side information on the DL forwarding delay parameter (e.g. dl-delay-ncr, or dldelay-ncr-fwd, or ncr-fwd-dl-delay, etc.) to determine the time resources for downlink reception on the backhaul link.

In one approach, the DL forwarding delay may be configured with a number of slots k. For an aperiodic DL transmission in slot n on the access link, the NCR forwards the received signal in slot n-k from the gNB on the backhaul link. In one case, the same time domain and frequency domain resources (if applicable) are used in both slots for the aperiodic DL transmissions. In another case, additional time domain offset can be configured in a separate parameter, e.g. timeDomainOffset, to adjust the position of the aperiod DL time resources to be buffered/forwarded in slot n-k. The offset value may be positive or negative in a number of symbols.

In another approach, the DL forwarding delay may be configured with a number of symbols N. The NCR forwards the received signals from the gNB on the backhaul link N symbols before the start of aperiodic DL transmission on the access link. The aperiodic DL time resource on the backhaul link should have the same duration as the time resource for the aperiodic DL time resource on the access link. The DL transmission timing of the NCR-Fwd on the access link is later than the DL reception time on the backhaul link of the NCR-MT and the NCR-Fwd by an internal delay. The internal delay includes the switching time and processing time for the NCR forwarding. Thus, it is possible to have N=0 for immediate forwarding of a DL transmission from gNB to the UE. Define the DL forwarding delay in a number of symbols may reduce the latency of a periodic DL transmission.

A single DL forwarding delay RRC parameter is configured applied to all aperiodic DL transmissions. The DL forwarding delay should be smaller than the distance between the DL beam indication DCI and the indicated aperiodic DL time resource to ensure the NCR can received and buffer the data on the corresponding time resource of the backhaul link.

Alternatively, the DL forwarding delay can be specified as the distance between the slot that carrying the NCR aperiodic beam indication DCI and the slot for the time resource on the backhaul link.

### Method 2: The Aperiodic DL Time Resource on the Backhaul Link is Implicitly or Explicitly Indicated by the Beam Indication DCI for the Access Link

The NCR may determine the backhaul link DL time resource for reception/buffering of the aperiodic DL transmission based on the content in the NCR aperiodic beam indication DCI for the access link. The NCR aperiodic beam indication DCI may be a DCI format for DL only beam and time resource indication. The NCR aperiodic beam indication DCI may be a united DCI format for DL or UL beam and time resource indication. The NCR aperiodic beam indication DCI may be a DCI format for combined DL and UL beam and time resources indication with an indicated DL access link time resource index.

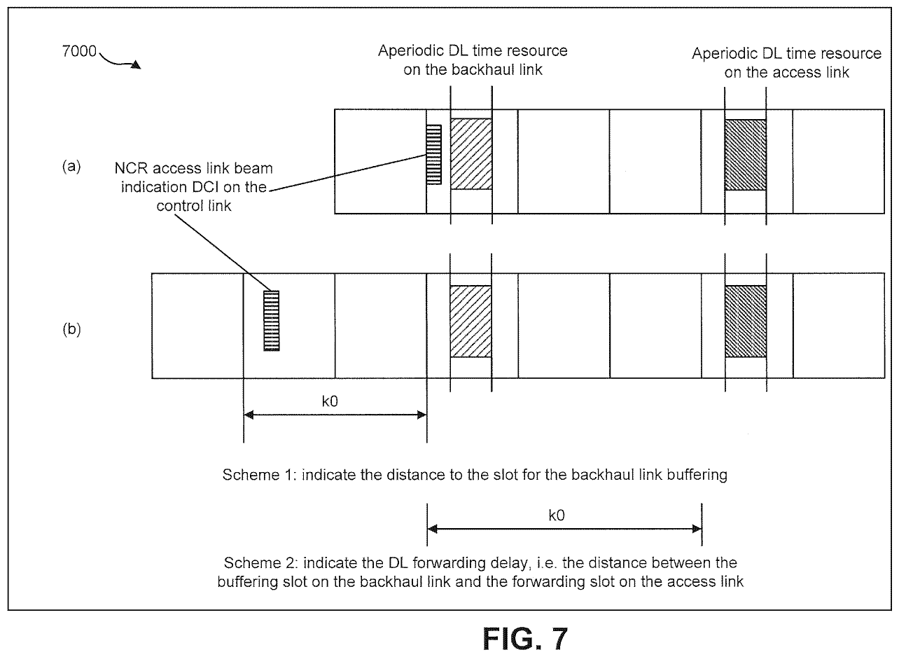

In one approach (Approach 1), the backhaul link slot and time resources are determined implicitly by the slot that carrying the NCR aperiodic beam indication DCI for the access link. The DL time resource on the backhaul link in the determined slot is the same as the DL time resources in the corresponding access link beam indication with DL time resource allocation, as shown in FIG. 7a.

FIG. 7 is a diagram 7000 showing methods to indicate the DL backhaul link time resource for an access link DL time resource.

The NCR buffers the DL time resources in the slot carrying the aperiodic beam indication DCI for the access link, then transmits the buffered signal on the aperiodic DL time resources with the indication beam(s) on the access link. The same start symbol index and duration is used for the buffered region in the slot on the backhaul link. Thus, in this approach, the DL forward delay is implicitly determined by the distance between the slot carrying the NCR aperiodic beam indication DCI for the access link and the aperiodic DL time resource on the access link. This provides a simple solution since the NCR buffers the slot anyway for potential backhaul link and/or control link signals. On the other hand, it limits the resources can be used for the backhaul link transmission.

In another approach (Approach 2), an explicit timing indication is included in the NCR aperiodic beam indication DCI for the access link. In the aperiodic beam indication DCI for the access link, an access link DL time resource index should be included, and a new field can be included in the DCI to indicate the DL time resources on the backhaul link. The new field can be called as a backhaul time resource indication field or a DL backhaul time resource indication field.

Item (b) of FIG. 7 shows two schemes to indicate the backhaul link DL time resource.

In one scheme (Scheme 1), the new field can be used to indicate the distance k0 between the slot of the aperiodic beam indication DCI and the DL slot for the backhaul link buffering, i.e. an explicit backhaul DL slot timing. If k0 is 0, the same slot carrying the aperiodic beam indication DCI is used for the data buffering on the backhaul link, same as the implicit method above. If k0 is greater than 0, then the slot that is k0 after the slot carrying the aperiodic beam indication DCI is used for the data buffering. And the buffer data is then forwarded on the indicated aperiodic DL time resources with the indicated beam(s) on the access link.

In another scheme (Scheme 2), the new field can be used to indicate the DL forwarding delay, i.e. the distance between the aperiodic DL time resources on the backhaul link and the aperiodic DL time resources on the access link. In this case, the DL forwarding delay should be a positive integer number of slots k0. The slot that is k0 before the slot of the access link aperiodic DL time resources is used for data buffering on the backhaul link. And the buffer data is transmitted on the indicated aperiodic DL time resources with the indicated beam(s) on the access link.

With Approach 2, the gNB can signal the aperiodic beam indication DCI and the backhaul resources with better flexibility. The aperiodic beam indication DCI may or may not in the same slot as the buffered data for forwarding on the backhaul link, and the timing can be adjusted based on the network traffic conditions.

Again, the indicated DL aperiodic time resource on the backhaul link should be later than the DL beam indication DCI, and earlier than the indicated aperiodic DL time resource, to ensure the NCR can received and buffer the data on the corresponding time resource of the backhaul link.

Method 2 and Method 1 can be used jointly. For example, a DL forwarding delay can be configured by RRC signaling. If an explicit field for the backhaul resource determination is available in the aperiodic beam indication DCI, the explicit timing indication is used to determine the backhaul DL time resource for the corresponding access link aperiodic time resource. Otherwise, if an explicit field for the backhaul resource determination is not available in the aperiodic beam indication DCI, the higher layer configured DL forwarding delay parameter is used to determine the backhaul DL time resource for the corresponding access link aperiodic time resource.

### Backhaul Link UL Time Resource Determination for a Dynamic UL Access Link Beam Indication

Similarly, for an aperiodic UL time resource, the gNB should indicate the aperiodic UL beam indication with beam, aperiodic UL time resource index on the access link for NCR reception/buffering from a UE; and an aperiodic UL time resource on the backhaul link for NCR forwarding to the gNB. The aperiodic UL time resource on the backhaul link may be determined by an uplink forwarding delay information and/or UL time resource allocation/indication on the backhaul link.

The UL time resources may be determined by a UL forwarding delay parameter. The UL forwarding delay parameter defines the time between the end of the UL reception at the NCR on the access link from UE and the beginning of the UL transmissions forwarded by the NCR on the backhaul link to the gNB.

Method 1: Specify an UL Forwarding Delay Parameter with Higher Layer Signaling

The UL forwarding delay can be signaled implicitly or explicitly. In one alternative (Alt. 1), the gNB can indication a side information on the UL forwarding delay parameter (e.g. ul-delay-ncr, or ul-delay-ncr-fwd, or ncr-fwd-ul-delay, etc.) to determine the time resources for downlink transmission on the backhaul link.

In one approach, the UL forwarding delay may be configured with a number of slots k. For aperiodic UL transmission in slot n received on the access link, the NCR forwards the received signal in slot n+k to the gNB on the backhaul link. In one case, the same time domain and frequency domain resources (if applicable) are used in both slots for the aperiodic UL transmissions. In another case, additional time domain offset can be configured in a separate parameter, e.g. timeDomainOffset, to adjust the position of the aperiod UL time resources to be buffered/forwarded in slot n+k. The offset value may be positive or negative in a number of symbols.

In another approach, the UL forwarding delay may be configured with a number of symbols N. The NCR forwards the received signals from the UE on the backhaul link N symbols after the end of aperiodic UL transmission on the access link. The aperiodic UL time resource on the backhaul link should have the same duration as the time resource for an aperiodic UL resource on the access link.

A single UL forwarding delay RRC parameter is configured applied to all aperiodic UL transmissions. Alternatively, a single forwarding delay parameter can be configured and applied to both aperiodic DL transmissions and aperiodic UL transmissions.

In another alternative, the UL forwarding delay can be specified as the distance between the slot that carrying the NCR aperiodic UL beam indication DCI and the slot for the UL time resource on the backhaul link.

### Method 2: The Aperiodic UL Time Resource on the Backhaul Link is Explicitly Indicated By the Beam Indication DCI for the Access Link

In another method, the aperiodic UL time resource on the backhaul link is explicitly indicated by the aperiodic beam indication DCI for access link.

The NCR may determine the backhaul link UL time resource for forwarding of the aperiodic DL transmission based on the content in the NCR aperiodic beam indication DCI for the access link. The NCR aperiodic beam indication DCI may be a DCI format for UL only beam and time resource indication. The NCR aperiodic beam indication DCI may be a united DCI format for DL or UL beam and time resource indication. The NCR aperiodic beam indication DCI may be a DCI format for combined DL and UL beam and time resources indication with an indicated UL access link time resource index.

In this method, an explicit timing indication is included in the NCR aperiodic beam indication DCI for the access link. In the aperiodic beam indication DCI for the access link, an access link UL time resource index should be included, and a new field can be included in the DCI to indicate the UL time resources on the backhaul link. new field can be called as a backhaul time resource indication field or an UL backhaul time resource indication field.

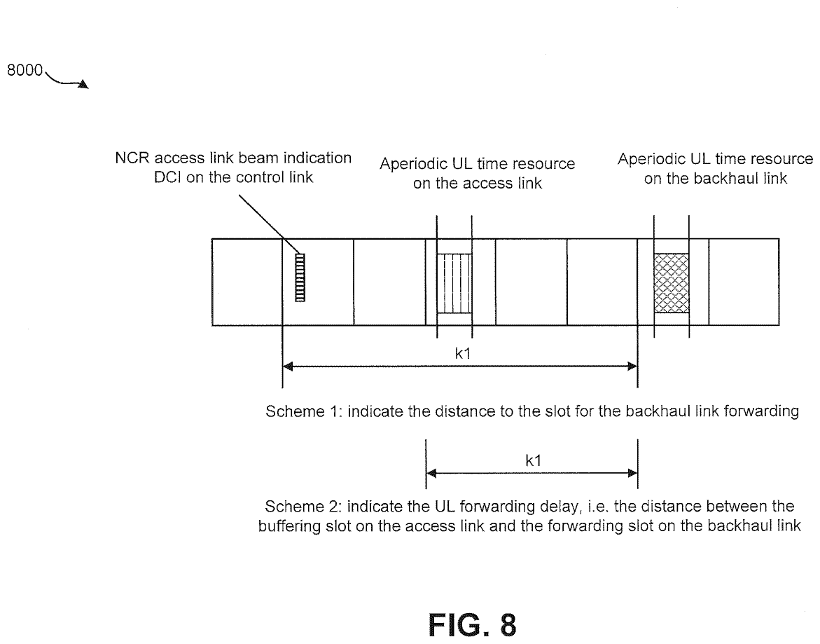

FIG. 8 is a diagram 8000 showing methods to indicate the UL backhaul link time resource for an access link UL time resource. FIG. 8 shows two schemes to indicate the backhaul link UL time resource.

In one scheme (Scheme 1), the new field can be used to indicate the distance k1 between the slot of the aperiodic beam indication DCI and the UL slot for the backhaul link buffering, an explicit backhaul UL slot timing. In this case, the slot that is k1 after the slot carrying the aperiodic beam indication DCI is used for the data forwarding. Thus, the indicated backhaul link slot should be later than the slot of the indicated access link aperiodic time resource.

In another scheme (Scheme 2), the new field can be used to indicate the UL forwarding delay, i.e. the distance between the aperiodic UL time resources on the access link and the aperiodic UL time resources on the backhaul link. In this case, the UL forwarding delay should be a positive integer number of slots k1. The slot that is k1 after the slot of the access link aperiodic UL time resources is used for data forwarding on the backhaul link.

The NCR receives the UL transmission on the indicated aperiodic UL time resource, and forwards in a later slot on the backhaul link based on the new field timing indication. With this approach, the gNB can signal the aperiodic beam indication DCI and the backhaul resources with better flexibility.

Method 2 and Method 1 can be used jointly. For example, a UL forwarding delay can be configured by RRC signaling. If an explicit field for the backhaul resource determination is available in the aperiodic beam indication DCI, the explicit timing indication is used to determine the backhaul UL time resource for the corresponding access link aperiodic time resource. Otherwise, if an explicit field for the backhaul resource determination is not available in the aperiodic beam indication DCI, the higher layer configured UL forwarding delay parameter is used to determine the backhaul UL time resource for the corresponding access link aperiodic time resource.

For a Type 1 transmission with both aperiodic DL and aperiodic UL transmission, the NCR should determine both the aperiodic DL time resources on the backhaul link and access link, and the aperiodic UL time resources on the backhaul link and access link.
Two DCIs are needed if separate aperiodic DL beam indication DCI and aperiodic UL beam indication are specified.
   An aperiodic DL beam indication DCI to indicate an aperiodic DL beam index, a DL time resource index, and an optional DL backhaul time resource indication field.
   An aperiodic UL beam indication DCI to indicate an aperiodic UL beam index, an UL time resource index, and an optional UL backhaul time resource indication field.
In case of a single aperiodic beam indication DCI can be used to indicate both aperiodic DL time resource and aperiodic UL aperiodic time resource.
   An aperiodic beam indication DCI format should include a DL beam index, a DL time resource index, an UL beam index, an UL time resource index, and optionally a DL backhaul time resource indication field and an UL backhaul time resource indication field. Alternatively, a single backhaul time resource indication field can be used both DL forwarding delay and UL forwarding delay.
      Network controlled repeater (NCR) control information for dynamic scheduled transmissions
      Focusing on unified DCI formats for DL and/or UL access beam indication and backhaul time resource determination.
      Case 1: A DL Transmission with UL Feedback May be Scheduled by Two DCIs for DL Transmission and UL Transmission Respectively.

The gNB should guarantee the correct timing and time resources are scheduled. The NCR does not need to know the relationship between the DL and UL transmissions.

In one method, the gNB signals a dedicated DL beam indication DCI and a dedicated UL beam indication DCI.

In another method, a new beam indication DCI for either DL or UL beam indication for access link can be specified. The DCI fields includes at least an access link beam index, an access link time resource, and a configurable field on the backhaul time resource indication.

The UL time resources list and the time resource indexes can be determined by two options:
Option 1: Separate lists for DL time resources and UL time resources respectively
Option 2: A joint list contains both DL time resources and UL time resources

A backhaul time resource indication field is configurable to be present or not. The interpretation of the field is determined based on the type of the time resource, i.e. DL or UL.
Method 1: NCR evaluates the time resource, i.e. DL or UL first based on the slot configure, then follow the corresponding operation
   The backhaul time resource indication field indicates a DL forwarding delay if a DL time resource is indicated
   The backhaul time resource indication field indicates a UL forwarding delay if a UL time resource is indicated
Method 2: A field is included in the DCI to explicit indicate whether the DCI is for DL or UL scheduling. The gNB should always indicate a time resource with the same direction.
Use RRC configured parameters if backhaul time resource indication field is not included in the DCI
   Case 2: a DL Transmission with UL Feedback May be Scheduled by a Beam Indication DCI with Multiple Beams and Time Resources.

A verbose DCI format can be specified for aperiodic beam indication with one or more time resources and beams. The DCI fields should include at least an access link DL beam index, an access link DL time resource index, an access link UL beam index, an access link UL time resource index, and one or two configurable fields on the backhaul time resource indication.
Option 1: two backhaul time resource indications for DL and UL respectively.
Option 2: A single forwarding delay may be configured and applied for both DL and UL.

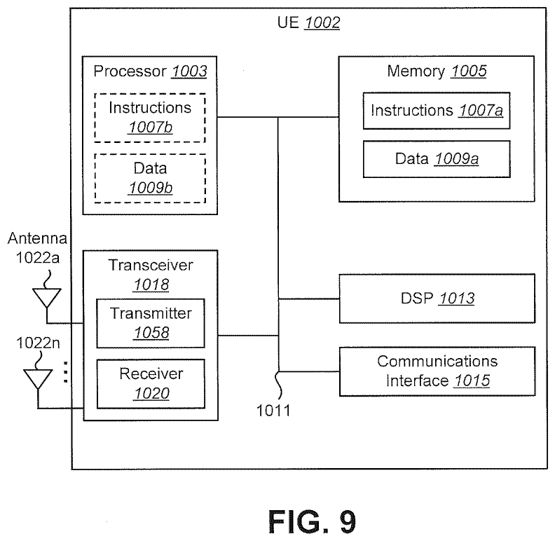

FIG. 9 illustrates various components that may be utilized in a UE 1002. The UE 1002 described in connection with FIG. 9 may be implemented in accordance with the UE 102 described in connection with FIG. 1. The UE 1002 includes a processor 1003 that controls operation of the UE 1002. The processor 1003 may also be referred to as a central processing unit (CPU). Memory 1005, which may include read-only memory (ROM), random access memory (RAM), a combination of the two or any type of device that may store information, provides instructions 1007a and data 1009a to the processor 1003. A portion of the memory 1005 may also include non-volatile random access memory (NVRAM). Instructions 1007b and data 1009b may also reside in the processor 1003. Instructions 1007b and/or data 1009b loaded into the processor 1003 may also include instructions 1007a and/or data 1009a from memory 1005 that were loaded for execution or processing by the processor 1003. The instructions 1007b may be executed by the processor 1003 to implement the methods described herein.

The UE 1002 may also include a housing that contains one or more transmitters 1058 and one or more receivers 1020 to allow transmission and reception of data. The transmitter(s) 1058 and receiver(s) 1020 may be combined into one or more transceivers 1018. One or more antennas 1022a-n are attached to the housing and electrically coupled to the transceiver 1018.

The various components of the UE 1002 are coupled together by a bus system 1011, which may include a power bus, a control signal bus and a status signal bus, in addition to a data bus. However, for the sake of clarity, the various buses are illustrated in FIG. 9 as the bus system 1011. The UE 1002 may also include a digital signal processor (DSP) 1013 for use in processing signals. The UE 1002 may also include a communications interface 1015 that provides user access to the functions of the UE 1002. The UE 1002 illustrated in FIG. 9 is a functional block diagram rather than a listing of specific components.

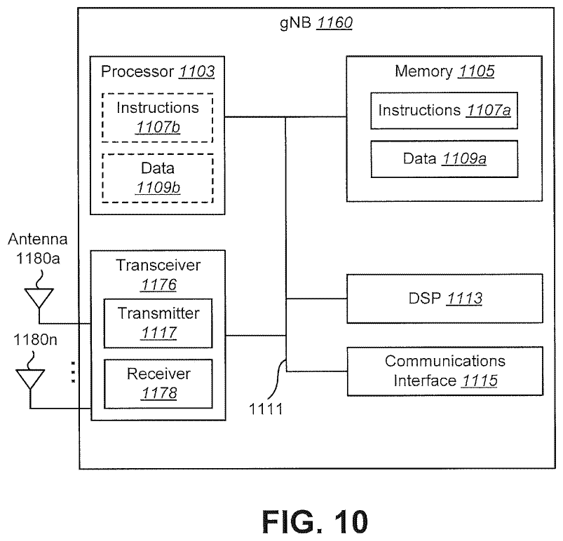

FIG. 10 illustrates various components that may be utilized in a gNB 1160. The gNB 1160 described in connection with FIG. 10 may be implemented in accordance with the gNB 160 described in connection with FIG. 1. The gNB 1160 includes a processor 1103 that controls operation of the gNB 1160. The processor 1103 may also be referred to as a central processing unit (CPU). Memory 1105, which may include read-only memory (ROM), random access memory (RAM), a combination of the two or any type of device that may store information, provides instructions 1107a and data 1109a to the processor 1103. A portion of the memory 1105 may also include nonvolatile random access memory (NVRAM). Instructions 1107b and data 1109b may also reside in the processor 1103. Instructions 1107b and/or data 1109b loaded into the processor 1103 may also include instructions 1107a and/or data 1109a from memory 1105 that were loaded for execution or processing by the processor 1103. The instructions 1107b may be executed by the processor 1103 to implement the methods described herein.

The gNB 1160 may also include a housing that contains one or more transmitters 1117 and one or more receivers 1178 to allow transmission and reception of data. The transmitter(s) 1117 and receiver(s) 1178 may be combined into one or more transceivers 1176. One or more antennas 1180a-n are attached to the housing and electrically coupled to the transceiver 1176.

The various components of the gNB 1160 are coupled together by a bus system 1111, which may include a power bus, a control signal bus and a status signal bus, in addition to a data bus. However, for the sake of clarity, the various buses are illustrated in FIG. 10 as the bus system 1111. The gNB 1160 may also include a digital signal processor (DSP) 1113 for use in processing signals. The gNB 1160 may also include a communications interface 1115 that provides user access to the functions of the gNB 1160. The gNB 1160 illustrated in FIG. 10 is a functional block diagram rather than a listing of specific components.

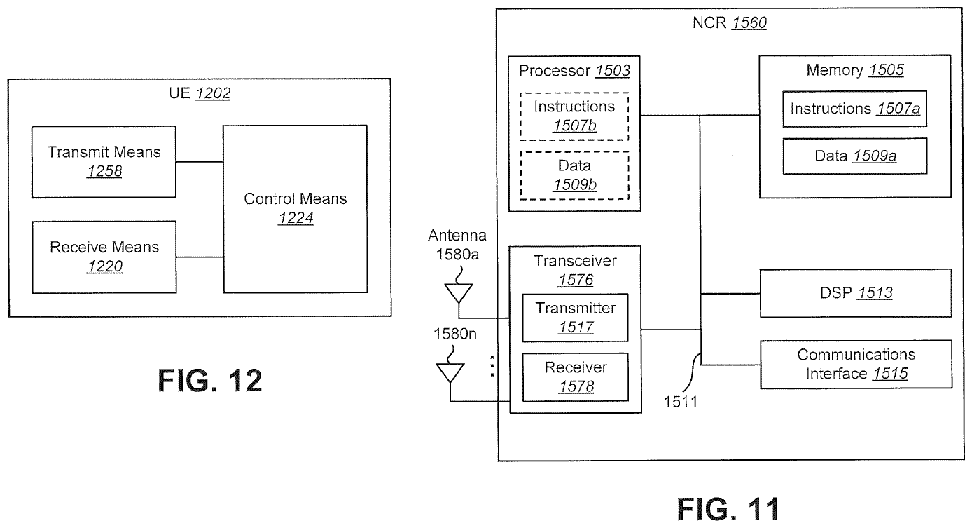

FIG. 11 illustrates various components that may be utilized in an NCR 1560. The NCR 1560 described in connection with FIG. 11 may be implemented in accordance with the NCR described herein. The NCR 1560 includes a processor 1503 that controls operation of the NCR 1560. The processor 1503 may also be referred to as a central processing unit (CPU). Memory 1505, which may include read-only memory (ROM), random access memory (RAM), a combination of the two or any type of device that may store information, provides instructions 1507a and data 1509a to the processor 1503. A portion of the memory 1505 may also include non-volatile random access memory (NVRAM). Instructions 1507b and data 1509b may also reside in the processor 1503. Instructions 1507b and/or data 1509b loaded into the processor 1503 may also include instructions 1507a and/or data 1509a from memory 1505 that were loaded for execution or processing by the processor 1503. The instructions 1507b may be executed by the processor 1503 to implement the methods described herein.

The NCR 1560 may also include a housing that contains one or more transmitters 1517 and one or more receivers 1578 to allow transmission and reception of data. The transmitter(s) 1517 and receiver(s) 1578 may be combined into one or more transceivers 1576. One or more antennas 1580a-n are attached to the housing and electrically coupled to the transceiver 1576.

The various components of the NCR 1560 are coupled together by a bus system 1511, which may include a power bus, a control signal bus and a status signal bus, in addition to a data bus. However, for the sake of clarity, the various buses are illustrated in FIG. 11 as the bus system 1511. The NCR 1560 may also include a digital signal processor (DSP) 1513 for use in processing signals. The NCR 1560 may also include a communications interface 1515 that provides user access to the functions of the NCR 1560. The NCR 1560 illustrated in FIG. 11 is a functional block diagram rather than a listing of specific components.

FIG. 12 is a block diagram illustrating one implementation of a UE 1202 in which one or more of the systems and/or methods described herein may be implemented. The UE 1202 includes transmit means 1258, receive means 1220 and control means 1224. The transmit means 1258, receive means 1220 and control means 1224 may be configured to perform one or more of the functions described in connection with FIG. 1 above. FIG. 9 above illustrates one example of a concrete apparatus structure of FIG. 12. Other various structures may be implemented to realize one or more of the functions of FIG. 1. For example, a DSP may be realized by software.

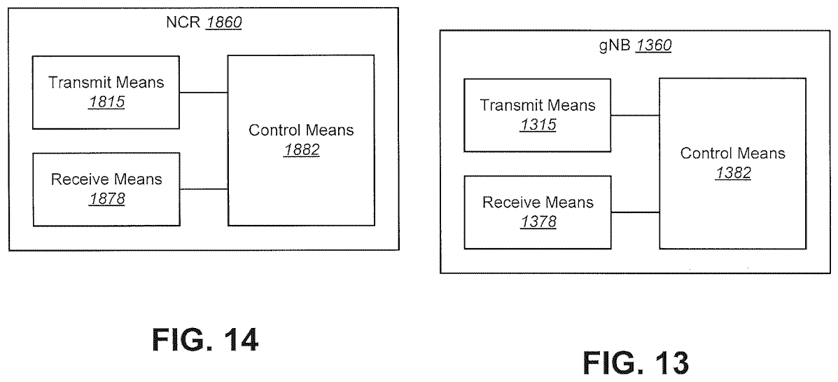

FIG. 13 is a block diagram illustrating one implementation of a gNB 1360 in which one or more of the systems and/or methods described herein may be implemented. The gNB 1360 includes transmit means 1315, receive means 1378 and control means 1382. The transmit means 1315, receive means 1378 and control means 1382 may be configured to perform one or more of the functions described in connection with FIG. 1 above. FIG. 10 above illustrates one example of a concrete apparatus structure of FIG. 13. Other various structures may be implemented to realize one or more of the functions of FIG. 1. For example, a DSP may be realized by software.

FIG. 14 is a block diagram illustrating one implementation of an NCR 1860 in which one or more of the systems and/or methods described herein may be implemented. The NCR 1860 includes transmit means 1815, receive means 1878 and control means 1882. The transmit means 1815, receive means 1878 and control means 1882 may be configured to perform one or more of the functions described herein. FIG. 11 above illustrates one example of a concrete apparatus structure of FIG. 14. Other various structures may be implemented to realize one or more of the functions of FIG. 1. For example, a DSP may be realized by software.

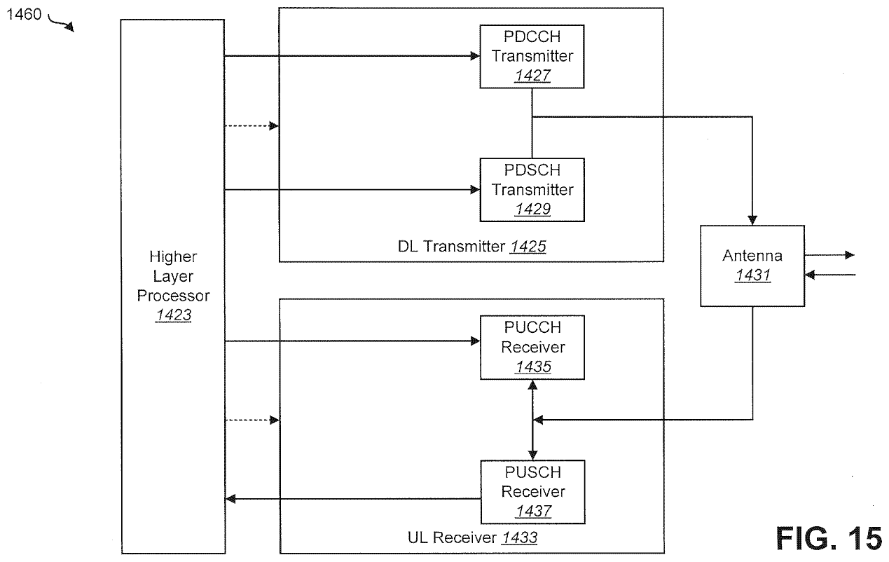

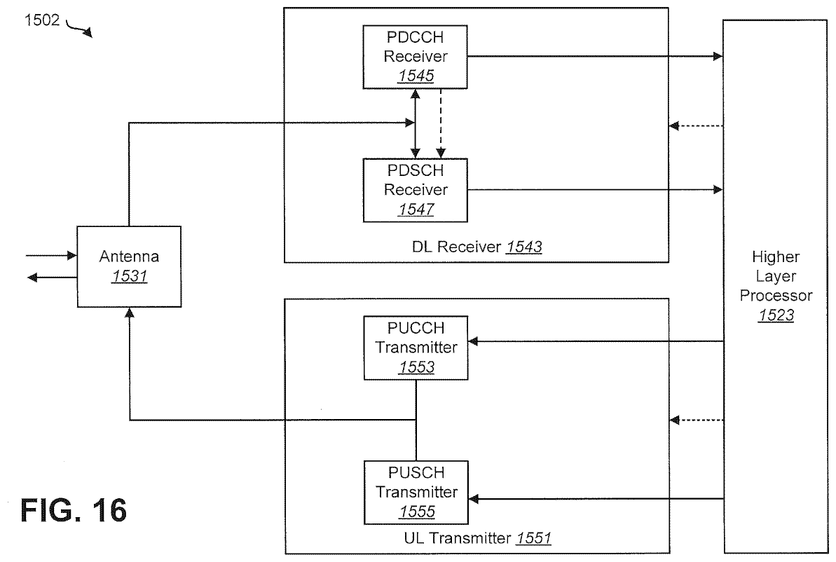

FIG. 15 is a block diagram illustrating one implementation of a gNB 1460. The gNB 1460 may be an example of the gNB 160 described in connection with FIG. 1. The gNB 1460 may include a higher layer processor 1423, a DL transmitter 1425, a UL receiver 1433, and one or more antenna 1431. The DL transmitter 1425 may include a PDCCH transmitter 1427 and a PDSCH transmitter 1429. The UL receiver 1433 may include a PUCCH receiver 1435 and a PUSCH receiver 1437.

The higher layer processor 1423 may manage physical layer's behaviors (the DL transmitter's and the UL receiver's behaviors) and provide higher layer parameters to the physical layer. The higher layer processor 1423 may obtain transport blocks from the physical layer. The higher layer processor 1423 may send/acquire higher layer messages such as an RRC message and MAC message to/from a UE's higher layer. The higher layer processor 1423 may provide the PDSCH transmitter transport blocks and provide the PDCCH transmitter transmission parameters related to the transport blocks.

The DL transmitter 1425 may multiplex downlink physical channels and downlink physical signals (including reservation signal) and transmit them via transmission antennas 1431. The UL receiver 1433 may receive multiplexed uplink physical channels and uplink physical signals via receiving antennas 1431 and de-multiplex them. The PUCCH receiver 1435 may provide the higher layer processor 1423 UCI. The PUSCH receiver 1437 may provide the higher layer processor 1423 received transport blocks.

FIG. 16 is a block diagram illustrating one implementation of a UE 1502. The UE 1502 may be an example of the UE 102 described in connection with FIG. 1. The UE 1502 may include a higher layer processor 1523, a UL transmitter 1551, a DL receiver 1543, and one or more antenna 1531. The UL transmitter 1551 may include a PUCCH transmitter 1553 and a PUSCH transmitter 1555. The DL receiver 1543 may include a PDCCH receiver 1545 and a PDSCH receiver 1547.

The higher layer processor 1523 may manage physical layer's behaviors (the UL transmitter's and the DL receiver's behaviors) and provide higher layer parameters to the physical layer. The higher layer processor 1523 may obtain transport blocks from the physical layer. The higher layer processor 1523 may send/acquire higher layer messages such as an RRC message and MAC message to/from a UE's higher layer. The higher layer processor 1523 may provide the PUSCH transmitter transport blocks and provide the PUCCH transmitter 1553 UCI.

The DL receiver 1543 may receive multiplexed downlink physical channels and downlink physical signals via receiving antennas 1531 and de-multiplex them. The PDCCH receiver 1545 may provide the higher layer processor 1523 DCI. The PDSCH receiver 1547 may provide the higher layer processor 1523 received transport blocks.

The term “computer-readable medium” refers to any available medium that can be accessed by a computer or a processor. The term “computer-readable medium,” as used herein, may denote a computer- and/or processor-readable medium that is nontransitory and tangible. By way of example and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray (registered trademark) disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD and the like), a magnetic storage medium (for example, a magnetic tape, a flexible disk and the like) and the like, any one may be possible. Furthermore, in some cases, the function according to the described systems and methods described herein is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described herein may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller, or a state machine. The general-purpose processor or each circuit described herein may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

### CROSS REFERENCE

This Nonprovisional application claims priority under 35 U.S.C. § 119 on provisional Application No. 63/446,254 on Feb. 16, 2023, the entire contents of which are hereby incorporated by reference.

1. A network controlled repeater (NCR) comprising:
receiving circuitry configured to:
receive a downlink control information (DCI) from a gNodeB (gNB) for an access link aperiodic downlink (DL) beam indication, including at least an access link DL beam index, an access link DL time resource index, and a configurable field on a backhaul time resource indication;
determine an aperiodic DL time resource on a backhaul link corresponding to the aperiodic DL time resource on the access link; and
receive and buffer a DL signal on the determined aperiodic DL time resource on the backhaul link;
transmitting circuitry configured to:
transmit the buffered DL signal from the backhaul link on the aperiodic DL time resource with the indicated beam on the access link.

2. The NCR of claim 1, wherein the access link aperiodic DL time resource index is determined based on a list for DL time resources only, or based on a joint list containing both DL time resources and uplink (UL) time resources.

3. The NCR of claim 1, wherein the aperiodic DL time resource on the backhaul link has the same start symbol and duration as the access link time resource, and wherein the slot for the backhaul link time resource is within or after the slot with the DL beam indication DCI and before the DL aperiodic time resource on the access link.

4. The NCR of claim 1, wherein if a backhaul time resource indication field is not available in the DL beam indication DCI, the aperiodic DL time resource on the backhaul link is determined by a radio resource control (RRC) configured parameter for a DL forwarding delay.

5. The NCR of claim 1, wherein if a backhaul time resource indication field is not available in the DL beam indication DCI, the aperiodic DL time resource on the backhaul link is determined in the slot carrying the beam indication DCI.

6. The NCR of claim 1, wherein if a backhaul time resource indication field is configured in the DL beam indication DCI, the aperiodic DL time resource on the backhaul link is determined by the backhaul time resource indication field, wherein the backhaul time resource indication field indicates the number of slots between the slot of the beam indication DCI and the backhaul link slot or the number of slots between the backhaul link slot and the access link slot.

7. A gNodeB (gNB) comprising:
transmitting circuitry configured to:
transmit a downlink control information (DCI) to a network controlled repeater (NCR) for an access link aperiodic downlink (DL) beam indication, including at least an access link DL beam index, an access link DL time resource index, and a configurable field on the backhaul time resource indication;
determine an aperiodic DL time resource on a backhaul link corresponding to the aperiodic DL time resource on the access link; and
transmit a DL signal on the determined aperiodic DL time resource on the backhaul link.

8. The gNB of claim 7, wherein the access link aperiodic DL time resource index is determined based on a list for DL time resources only, or based on a joint list containing both DL time resources and uplink (UL) time resources.

9. The gNB of claim 7, wherein the aperiodic DL time resource on the backhaul link has the same start symbol and duration as the access link time resource, and wherein the slot for the backhaul link time resource is within or after the slot with the DL beam indication DCI, and before the DL aperiodic time resource on the access link.

10. The gNB of claim 7, wherein if a backhaul time resource indication field is not available in the DL beam indication DCI, the aperiodic DL time resource on the backhaul link is determined by a radio resource control (RRC) configured parameter for a DL forwarding delay.

11. The gNB of claim 7, wherein if a backhaul time resource indication field is not available in the DL beam indication DCI, the aperiodic DL time resource on the backhaul link is determined in the slot carrying the beam indication DCI.

12. The gNB of claim 7, wherein if a backhaul time resource indication field is configured in the DL beam indication DCI, the aperiodic DL time resource on the backhaul link is determined by the backhaul time resource indication field, wherein the backhaul time resource indication field indicates the number of slots between the slot of the beam indication DCI and the backhaul link slot or the number of slots between the backhaul link slot and the access link slot.

13. A communication method of a network controlled repeater (NCR), comprising:
receiving a downlink control information (DCI) from a gNodeB (gNB) for an access link aperiodic downlink (DL) beam indication, including at least an access link DL beam index, an access link DL time resource index, and a configurable field on the backhaul time resource indication;
determining an aperiodic DL time resource on a backhaul link corresponding to the aperiodic DL time resource on the access link;
receiving and buffering a DL signal on the determined aperiodic DL time resource on the backhaul link; and
transmitting the buffered DL signal from the backhaul link on the aperiodic DL time resource with the indicated beam on the access link.
